(19) United States
(12) Patent Application Publication
(10) Pub. No.: US 2015/0101153 A1
(43) Pub. Date: Apr. 16, 2015

(54) SEATBELT SAFETY COVER

(71) Applicant: Isobel Cuppan, Irving, TX (US)

(72) Inventor: Isobel Cuppan, Irving, TX (US)

(21) Appl. No.: 14/050,536

(22) Filed: Oct. 10, 2013

(51) Int. Cl. A44B 11/25; B60R 22/10

(52) U.S. Cl. CPC A44B 11/2576; B60R 22/105; B60R 2022/006
USPC 24/163 K

(57) ABSTRACT

A seatbelt safety cover for a seatbelt comprising a housing to envelop a buckle of the seatbelt, where the housing includes an inner cavity to receive the buckle and an opening at each lateral end of the housing to enable a strap to exit the housing; a front face of the housing, where the front face is positioned above the buckle; a back face of the housing, where the back face is positioned behind the buckle; and an end connecting the front face to the back face. The housing may include a hinge to open and close the front face.

### BACKGROUND OF THE INVENTION

1. Field of the Invention

The present invention relates to a seatbelt cover that prevents a child from unfastening a seatbelt.

2. Description of Related Art

While traveling in a vehicle is it required that all passengers wear a seatbelt. Those individuals who disobey this law are subject to receiving tickets and fines. To ensure that they do not receive a fine or ticket, the parent or guardian of an infant or a child must secure the child into their seatbelt. Once all of the children are secure the parent may then fasten their own belt and continue on their travels. Likewise, guardians of mentally handicapped individuals must secure the individual to ensure that their seatbelt is in place before they start operating the vehicle.

Commonly, the child or mentally challenged individual may fidget and play while they are in their seat. While playing, they may inadvertently undo the seatbelt, causing them to be free and insecure in their seat. Alternatively, if the person is uncomfortable they may purposely unbuckle the belt to relieve their discomfort. Either way it problematic and unsafe for the driver to have persons not buckled while driving a vehicle.

Therefore it would be beneficial in the art to provide a lock that prevents a child from unfastening their seatbelt without the parent's consent. It would also be desirable in the art to provide a seatbelt cover that is easily removable by the driver when necessary.

### SUMMARY OF THE INVENTION

In view of the foregoing disadvantages inherent in the prior art, the general purpose of the present invention is to provide a seatbelt safety cover for a seatbelt, configured to include all of the advantages of the prior art, and to overcome the drawbacks inherent therein.

Accordingly, an object of the present invention is to provide a seatbelt cover that securely clips around a seatbelt buckle to prevent a child from unfastening the buckle.

To achieve the above objects, in an aspect of the present invention, a seatbelt safety cover is described comprising a housing to envelop a buckle of the seatbelt, where the housing includes an inner cavity to receive the buckle and an opening at each lateral end of the housing to enable a strap to exit the housing; a front face of the housing, where the front face is positioned above the buckle; a back face of the housing, where the back face is positioned behind the buckle; and an end connecting the front face to the back face. The housing may include a hinge to open and close the front face.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings in which:

FIG. 1(A) depicts a perspective view of a seatbelt in accordance with an exemplary embodiment of the present invention; and

FIG. 1(B) depicts a perspective view of a seatbelt safety cover in accordance with an exemplary embodiment of the present invention.

### DETAILED DESCRIPTION OF THE DRAWINGS

The present invention relates to a seatbelt cover that prevents a child from unfastening a seatbelt. The present invention provides a seatbelt safety cover that clips over a seatbelt buckle to prevent a user from pressing the release button. The seatbelt safety cover prevents both children and/or mentally challenged individuals from unbuckling the fastener without assistance. Both practical and convenient, the seatbelt safety cover is lightweight and easy to use attaching to any seatbelt rapidly and effortlessly.

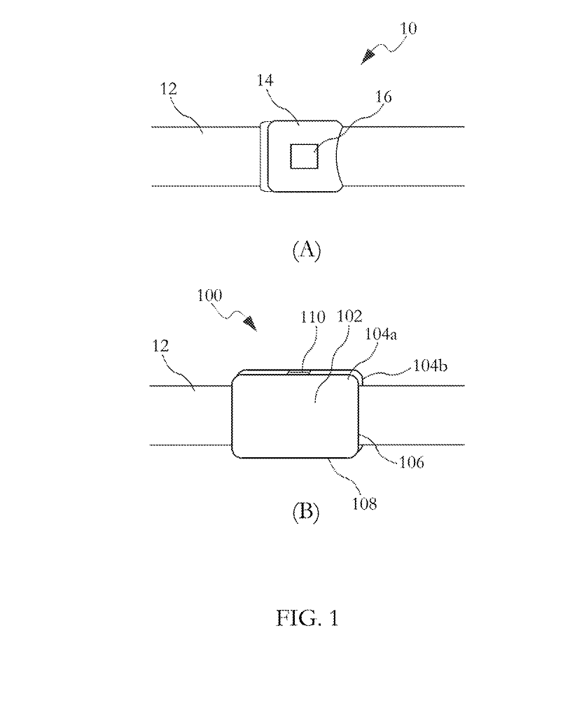

Turning now descriptively to the drawings, referring to FIG. 1(A), a seatbelt 10 is shown in accordance with an exemplary embodiment of the present invention. The seatbelt 10 typically includes a strap 12 to wrap around a waist and/or a torso of a user. The seatbelt 10 secures the user in place with the strap 12 which fastens into a buckle 14. The buckle 14 includes a button 16 to release the buckle 14 and separate the straps 12.

Referring now to FIG. 1(B) a seatbelt safety cover 100 is shown in accordance with an exemplary embodiment of the present invention. The seatbelt safety cover 100 is positioned over the buckle of the seatbelt. The seatbelt safety cover 100 includes a housing 102 which completely envelopes the buckle. The housing 102 may be approximately the size of a matchbox to cover the button on the buckle. The housing 102 includes a front face 104a and a back face 104b. The front face 104a and the back face 104b create a cavity to receive the buckle. The front face 104a is positioned above the buckle and the button. The back face 104b is positioned behind the buckle between the user and a backside of the buckle. The housing 102 may be made from a plastic, steel or aluminum material.

On each lateral end of the housing 102 is an opening 106 which enables the strap 12 to attach to the fastened buckle. The front face 104a and the back face 104b are attached to each other on an end 108. During use, the housing 102 may slip around the buckle like a clip, where the front face 104a and the back face 104b remain in position with tension around the buckle.

Alternatively, the end 108 may include a hinge to open and close the housing 102. On a top edge of the housing 102 may be a latch 110. During use, the hinge opens the housing 102 to receive the buckle into the cavity, and then close the front face 104a over the button. The latch 110 locks the front face 104a to the back face 104b to close the housing 102. With the housing 102 in place, the user secured within the seatbelt is blocked from pressing the button on the buckle. This way a child or mentally challenged person cannot undo the seatbelt by simply fidgeting with the buckle. The parent or guardian must remove the seatbelt safety cover 100 before unlocking the seatbelt. By utilizing the seatbelt safety cover 100 the guardian is afforded peace of mind that their child will not escape the seatbelt without their knowledge or desire.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A seatbelt safety cover for a seatbelt comprising:
a. a housing to envelop a buckle of the seatbelt, where the housing includes an inner cavity to receive the buckle and an opening at each lateral end of the housing to enable a strap to exit the housing;
b. a front face of the housing, where the front face is positioned above the buckle;
c. a back face of the housing, where the back face is positioned behind the buckle; and
d. an end connecting the front face to the back face.

2. The seatbelt safety cover according to claim 1, where the front face and the back face are held in place with tension.

3. The seatbelt safety cover according to claim 1, where the end includes a hinge to open and close the housing.

4. The seatbelt safety cover according to claim 3, where the housing includes a latch at a top edge, where the latch locks the front face to the back face.

5. The seatbelt safety cover according to claim 1, where the housing is made from one of at least plastic, steel or aluminum.
